(19) United States
(12) Patent Application Publication
(10) Pub. No.: US 2011/0234018 A1
(43) Pub. Date: Sep. 29, 2011

(54) CONTROL CIRCUIT FOR AN ELECTRONIC HOUSEHOLD APPLIANCE

(75) Inventor: Fritz Siebachmeyer, Neukirch (DE)

(73) Assignee: DIEHL AKO STIFTUNG & CO. KG, Wangen (DE)

(21) Appl. No.: 13/069,784

(22) Filed: Mar. 23, 2011

(30) Foreign Application Priority Data
Mar. 23, 2010 (DE) DE 102010012311.0

(51) Int. Cl. H01H 9/54

(52) U.S. Cl. 307/139

(57) ABSTRACT

A control circuit for an electronic household appliance has a control device for controlling the operation of a unit of the appliance. The control device is connected to a supply system via a supply line. A switching device for optionally connecting or disconnecting the control device to or from the supply system is arranged in the supply line. To reduce the energy consumption in stand-by mode of the electronic household appliance, the switching device has a switching contact, arranged in the supply line, with a bistable switching characteristic. A mechanical actuator switches the switching contact into the switching state connecting the control device to the supply system. The actuator is coupled to an operating element that can be operated by a user. An electrical tripping device switches the switching contact into the switching state disconnecting the control device from the supply system. The tripping device is activated by an off signal received from the control device.

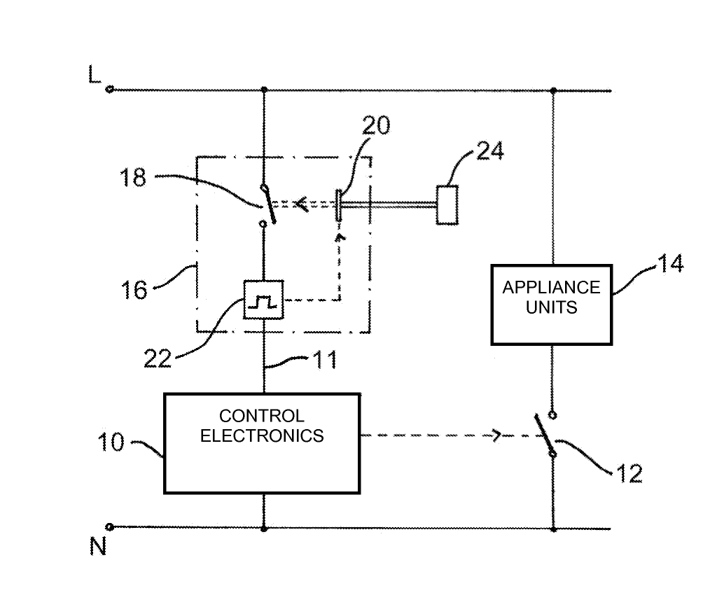

### CROSS-REFERENCE TO RELATED APPLICATION

This application claims the priority, under 35 U.S.C. §119, of German patent application DE 10 2010 012 311.0, filed Mar. 23, 2010; the prior application is herewith incorporated by reference in its entirety.

### BACKGROUND OF THE INVENTION

### Field of the Invention

The present invention relates to a control circuit for an electronic household appliance with a control device for controlling the operation of a unit of the appliance. The control device is connected to a supply system via a supply line and a switching device selectively connects or disconnects the control device to or from the supply system.

It is a general requirement to keep the energy demand of electronic appliances such as, for example, domestic appliances, as low as possible both in the operating state and also in stand-by mode. Thus, for example, the so-called ecodesign guideline 2005/32/EG of the European Union demands the minimization of the power consumption of energy-operated appliances in the switched-off state. In this context, the switched off state or stand-by state, respectively, is considered to be the operating state which is achieved after a predetermined work cycle has expired in normal use without the appliance being manually switched off.

In such a switched-off state, all units of the household appliance are normally electrically switched off, i.e. disconnected from the power supply. In the case of conventional control circuits of this type, however, the control electronics also continue to be connected to the supply system in stand-by mode and continuously extract energy from it. This energy extraction can possibly be kept very low with additional electronic expenditure.

A further approach to a solution is the use of a switch which, in stand-by mode, automatically disconnects the control electronics completely from the supply system and thus avoids any further energy extraction. Such disconnection of the control electronics from the supply system then requires the appliance to be switched on for renewed operation. Such a restart does not require any power supply since the control electronics are still disconnected from the supply system at that time.

### SUMMARY OF THE INVENTION

It is accordingly an object of the invention to provide a improved control circuit for an electronic household appliance which overcomes a variety of disadvantages of the heretofore-known devices and methods of this general type and which provides for an improved control circuit that provides for a further reduction in the energy consumption in stand-by mode.

With the foregoing and other objects in view there is provided, in accordance with the invention, a control circuit for an electronic household appliance having a control device for controlling an operation of a unit of the electronic household appliance, the control circuit comprising:

a supply line for connecting the control device to a supply system and a switching device connected in said supply line for selectively connecting or disconnecting the control device to or from the supply system;

said switching device including:
a switching contact having a bistable switching characteristic with a first switching state in which the control device is connected to the supply system and a second switching state in which the control device is disconnected from the supply system;
a mechanical actuator disposed to switch said switching contact into said first switching state connecting the control device to the supply system;
an operating element coupled to said actuator and disposed for activation by a user; and
an electrical tripping device for switching said switching contact into said second switching state disconnecting the control device from the supply system, said tripping device being connected to the control device and activatable by an off signal from the control device.

In a preferred implementation, the switching contact of the switching device is connected in the supply line.

In other words, the objects of the invention are achieved by a control circuit for an electronic household appliance that has a control device for controlling the operation of a unit of the electronic household appliance. The control device is connected to a supply system via a supply line. In the supply line, a switching device for optionally connecting or disconnecting the control device to or from the supply system, respectively, is arranged. The switching device has the following components:

a switching contact, arranged in the supply line, with a bistable switching characteristic;

a mechanical actuator for switching the switching contact into the switching state connecting the control device to the supply system, the actuator being coupled to an operating element which can be activated by a user; and

an electrical tripping device for switching the switching contact into the switching state disconnecting the control device from the supply system, the tripping device being activatable by an off signal from the control device.

The control circuit according to the invention for an electronic household appliance is characterized by a simple structure of the switching device. In particular, the switching device contains relatively few components as a result of which the production effort and the production costs can be kept low.

In addition, the switching device enables the control device of the electronic household appliance to be completely disconnected from the supply system in stand-by mode so that the control device no longer draws any energy from the latter in stand-by mode. This is made possible due to the fact that the switching contact of the switching device has a bistable switching characteristic and the switching contact is switched into the switching state connecting the control device to the supply system, i.e. the control device is switched on by means of a mechanical actuator, i.e. without supply of electrical energy.

The mechanical actuator of the switching device is coupled to an operating element which can be (manually) activated by a user. In this manner, the electronic household appliance or its control device, respectively, can be taken into operation again out of the stand-by mode in a simple manner by the user.

To switch the switching contact into the switching state disconnecting the control device from the supply system, i.e. for switching the control device off, the switching device contains an electrical tripping device which can be activated by an off signal from the control device. Since the control device is connected to the supply system in the switch-on operating state, the tripping of the switching device for switching the control device off into stand-by mode can be carried out electrically.

In an embodiment of the invention, the switching contact of the switching device is arranged in the supply line. This can provide for a particularly simple structure and/or operation of the switching device.

In a further embodiment of the invention, the supply line is used at the same time as a signal line of the tripping device for the off signal from the control device. Due to this measure, additional signal lines can be omitted, for example, which can lead to a simple and cost-effective structure of the control circuit.

In this embodiment, the tripping device of the switching device has, for example, a current detection device arranged in the supply line. As a result, it is possible, for example, that the control device sends a current pulse as off signal via the supply line to the switching device which pulse is detected by the current detection device in order to finally switch the switching contact of the switching device into the switching state disconnecting the control device from the supply system.

The tripping device of the switching device can have, for example, a thermal or magnetic tripping mechanism.

In accordance with an added feature of the invention, a protective circuit breaker is used for the switching device, described above, of the control circuit. As a result, the control circuit can be constructed with conventional components and thus cost effectively.

In accordance with an added feature of the invention, the operating element coupled to the actuator of the switching device can be integrated in a control panel of the electronic household appliance.

In this arrangement, the operating element coupled to the actuator of the switching device can be, for example, a separate operating element or an operating element integrated into another operating element in the control panel of the electronic household appliance.

The mechanical actuator and the operating element preferably form an integral constructional unit. In this manner, the number of components can be reduced.

The control circuit described above is advantageously suitable for electronic household appliances such as, for example, washing machines, laundry driers, combined washer/driers, dishwashers, stoves, cooking panels, microwave ovens, and the like.

Other features which are considered as characteristic for the invention are set forth in the appended claims.

Although the invention is illustrated and described herein as embodied in a control circuit for an electronic household appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing is a schematic diagram of a control circuit according to the invention.

### DETAILED DESCRIPTION OF THE INVENTION

Referring now to the FIGURE of the drawing in more detail, there is shown diagrammatically the structure of a control circuit according to the invention for an electronic household appliance. By way of example, the electronic household appliance, or domestic appliance, is a washing machine.

The control circuit contains a control device for control electronics 10 which are connected via a supply line 11 to the terminals L and N of a supply system. The unit or the units 14 of the household appliance (e.g. drive motor of the laundry drum in the case of a washing machine) are driven by the control device 10 via a switching element 12 in a conventional manner.

In the supply line 11 of the control device 10 there is provided a switching device 16 which, for example, can be implemented by a protective circuit breaker. The switching device 16 is used for optionally connecting the control device 10 to the supply system L, N (i.e. switching-on of the control device) or disconnecting the control device 10 from the supply system L, N (i.e. switching-off of the control device) in stand-by mode of the washing machine.

For this purpose, the switching device 16 contains a switching contact 18 which is arranged in the supply line 11. When the switching contact 18 is closed, the control device 10 is connected to the supply system L, N, when the switching contact 18 is opened, the control device 10 is disconnected from the supply system L, N.

The switching contact 18 has a bistable switching characteristic. i.e. the switching contact 18 remains in one of the two switching states until the switching state of the switching contact 18 is deliberately changed.

A mechanical actuator 20 is provided for closing the switching contact 18. This mechanical actuator 20 is coupled to an operating element 24 in the control panel of the household appliance, which can be manually operated by a user. The closing process of the switching contact 18 via the actuator 20 does not need any electrical energy from the supply system L, N.

In one variant of the embodiment, the mechanical actuator 20 is a plunger which is permanently connected to an operating element 24 as a singular or separate constructional element in the control panel. However, design variants are also possible in which either only the actuator 20 or the entire switching device 16 is integrated in a rotary programme selector 24 in the control panel. In this case, a preferred embodiment consists in placing the extension of the plunger 20 centrally in the center of the rotary selector knob. In another variant of the embodiment, the actuator 20 or the switching device 16 can also be integrated in a row of push buttons in the operating panel of the household appliance.

In a preferred embodiment, the plunger forming the mechanical actuator 20 forms at the same time the operating element 24 in the control panel. In other words, the actuator 20 and the operating element 24 are constructed as an integral constructional unit in this case.

The switching device 16 also comprises a current sensor 22 which serves as an electrical tripping device of the invention with a thermal or magnetic tripping mechanism. This current sensor 22 detects an off signal (e.g. a current pulse) transmitted by the control device 10 via the supply line 11 used as a signal line. The tripping mechanism of the tripping device 22 causes a detachment of the actuator 20 or an opening of the switching contact 18, respectively, so that the control device 10 is disconnected from the supply system L, N.

To implement a thermal tripping mechanism, bimetallic elements or linear expansion elements, for example, can be used through which the supply current of the control device 10 flows. For a magnetic tripping mechanism, a coil can be used, for example.

Since the control device 10 can be completely disconnected from the supply system L, N by this switching device 16 in stand-by mode, it no longer draws any energy from the supply system L, N which leads to a distinct reduction in the energy consumption of the household appliance equipped with such a control circuit.

When taking the household appliance into operation, the user operates the operating element 24 and thus closes the switching contact 18 with the aid of the mechanical actuator 20. In this manner, the control device 10 is connected to the supply system L, N, i.e. supplied with energy, and thus switched on. The household appliance is then used in accordance with its programme in the habitual manner.

After the end of the programme, the control device 10 automatically and independently disconnects itself from the supply system L, N by connecting a corresponding off signal in the form of the current pulse to the supply line 11. This current pulse is detected by the current sensor 22 which then triggers the actuator 20 via its thermal or magnetic tripping mechanism in order to open the switching contact 18. During this operation, the current pulse should be present until the switching contact 18 is opened in order to ensure that the control device 10 is reliably switching into a currentless state.

The switching contact 18 then remains in its open state until it is closed again by an operation of the operating element 24 and thus of the mechanical actuator 20 and the switching device 16, as a result, changes into its on-state.

1. A control circuit for an electronic household appliance having a control device for controlling an operation of a unit of the electronic household appliance, the control circuit comprising:
a supply line for connecting the control device to a supply system and a switching device connected in said supply line for selectively connecting or disconnecting the control device to or from the supply system;
said switching device including:
a switching contact having a bistable switching characteristic with a first switching state in which the control device is connected to the supply system and a second switching state in which the control device is disconnected from the supply system;
a mechanical actuator disposed to switch said switching contact into said first switching state connecting the control device to the supply system;
an operating element coupled to said actuator and disposed for activation by a user; and
an electrical tripping device for switching said switching contact into said second switching state disconnecting the control device from the supply system, said tripping device being connected to the control device and activatable by an off signal from the control device.

2. The control circuit according to claim 1, wherein said switching contact of said switching device is connected in said supply line.

3. The control circuit according to claim 1, wherein said supply line is configured as a signal line of said tripping device for receiving the off signal from the control device.

4. The control circuit according to claim 3, wherein said tripping device of said switching device includes a current detection device arranged in said supply line.

5. The control circuit according to claim 1, wherein said tripping device of said switching device has a thermal or magnetic tripping mechanism.

6. The control circuit according to claim 1, wherein said switching device is a protective circuit breaker.

7. The control circuit according to claim 1, wherein said operating element coupled to said actuator of said switching device is integrated in a control panel of the electronic household appliance.

8. The control circuit according to claim 7, wherein said operating element is a separate operating element or an operating element integrated into another operating element in the control panel of the electronic household appliance.

9. The control circuit according to claim 1, wherein said mechanical actuator and said operating element form an integral constructional unit.
